(19) United States
(12) Patent Application Publication
(10) Pub. No.: US 2002/0149469 A1
(43) Pub. Date: Oct. 17, 2002

(54) Single point failure avoidance for a keyless passive entry and immobilizer system

(75) Inventor: Joseph R. Thompson JR., Commerce Township, MI (US)

Correspondence Address: LAURA M. SLENZAK, SIEMENS CORPORATION, 186 WOOD AVENUE SOUTH, ISELIN, NJ, 08830, US

(73) Assignee: Siemens VDO Automotive Corporation

(21) Appl. No.: 10/118,980

(22) Filed: Apr. 9, 2002

Related U.S. Application Data
(60) Provisional application No. 60/283,552, filed on Apr. 12, 2001.

(51) Int. Cl. G05B 19/00

(52) U.S. Cl. 340/5.61; 340/5.72

(57) ABSTRACT

A keyless entry system includes a RF/LF transmitter (24), a passive signaling device (22), an entry antenna (32), a passive entry module PEM (34), an electronics module (36) and a transponder antenna (38). The transponder antenna (38) communicates directly with the electronics module (36). Should the PEM fail, locating the passive signaling device (22) adjacent the transponder antenna (38) will authorize engine start. Since the transponder antenna (38) does not communicate with the electronics module (36) through the PEM (34), failure of the PEM (34) does not result in a vehicle immobilizing single point failure.

The present application claims priority to United States Provisional Patent Application Serial No. 60/283,552, filed Apr. 12, 2001.

### BACKGROUND OF THE INVENTION

The present invention relates to a keyless entry system, and more particularly to a system which minimizes the possibility of a single point failure.

There are a variety of keyless entry systems currently available. One use for such systems is for gaining access to a vehicle. The systems also sometimes provide the ability to remotely control various features of the vehicle such as an ignition system to immobilize the vehicle unless an authorized signal is received.

Although quite convenient, there may be problems with the currently available keyless entry systems. One problem is the possibility of a single component failure resulting in the complete immobilization of the vehicle. Such a failure may be as simple as a depleted battery, yet due to the immobilization features, complete vehicle disablement results.

Accordingly, it is desirable to provide a keyless entry system which minimizes single point failures.

### SUMMARY OF THE INVENTION

The keyless entry system according to the present invention provides a passive signaling device which includes a radio frequency/low frequency (RF/LF) transmitter. The keyless entry system includes an entry antenna, a passive entry module (PEM), an electronics module and a transponder antenna. The transponder antenna communicates directly with the electronics module.

Should the PEM fail, locating the passive signaling device adjacent the transponder will authorize engine start. Whether the transmitter has an operational power source in this scenario is irrelevant, as the passive signaling device communicates with the transponder antenna. That is, since the transponder antenna does not communicate with the electronics module through the PEM, failure of the PEM will not result in a single point failure.

The present invention therefore provides a keyless entry system which minimizes single point failures.

### BRIEF DESCRIPTION OF THE DRAWINGS

The various features and advantages of this invention will become apparent to those skilled in the art from the following detailed description of the currently preferred embodiment. The drawing that accompanies the detailed description can be briefly described as follows:

FIG. 1 is a general schematic view of a vehicle having a keyless entry system according to the present invention.

### DETAILED DESCRIPTION OF THE PREFERRED EMBODIMENT

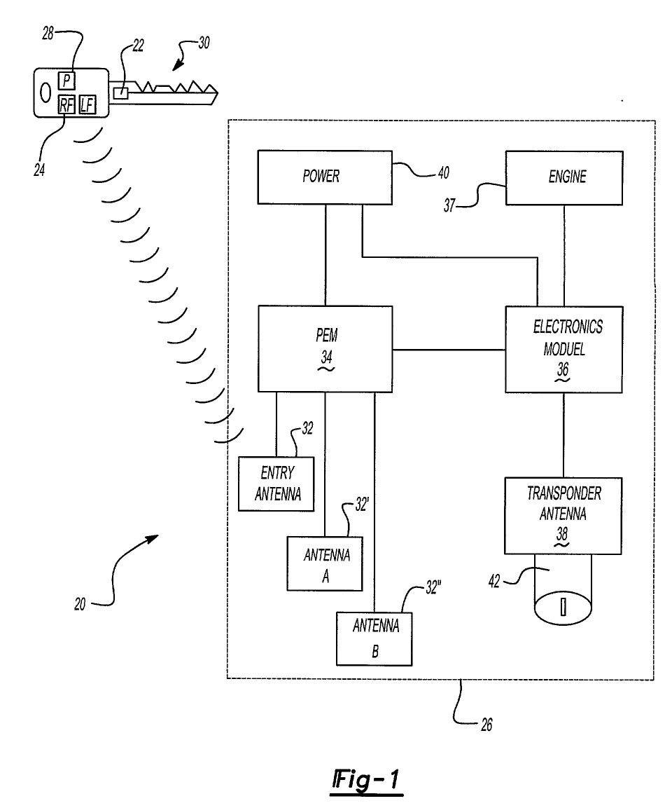

FIG. 1 illustrates a keyless entry system 20 which includes a passive signaling device 22. As generally known, the passive signaling device 22 includes a resonant circuit which cooperates with the keyless entry system 20 to provide an authentication signal. The passive signaling device 22 is preferably incorporate with a radio frequency/low frequency (RF/LF) transmitter 24 that remotely provides an authentication signal. The transmitter 24 must be located within a certain vicinity of the vehicle (illustrated schematically at 26) before the keyless entry system 20 will recognize the authentication signal from the transmitter 24. Preferably, the transmitter 24 operates actively under its own power source 28 to transmit an authorizing signal (illustrated schematically at 29). Most preferably, a key 30 includes the passive signaling device 22 and the RF/LF transmitter 24, however, other devices such as a card or keypad will benefit from the present invention. It should be understood that other transmitters that require manual activation such as through depressing a button or the like will also benefit from the present invention.

Referring to FIG. 1, the keyless entry system 20 is schematically illustrated. The keyless entry system 20 preferably includes an entry antenna 32, a passive entry module (PEM) 34, an electronics module 36 and a transponder antenna 38. The system 20 is powered by a power source such as vehicle battery 40 which preferably provides power directly to the PEM 34 and electronics module 36.

The PEM 34 is often referred to as a convenience feature module as multiple vehicle systems may be controlled thereby. One or more additional antenna 32′, 32″ may therefore additionally communicate with the PEM 34 to provide for operation of the other vehicle systems.

The electronics module 36 is programmed to enable or disable the vehicle engine 37 depending on proper signals from the passive and/or manual signaling devices. The electronics module 36 may additionally provide separate engine immobilization and security features. The entry antenna 32 communicates remotely with the transmitter 24 while the transponder antenna 38 communicates with the passive entry device 22.

The transponder antenna 38 communicates directly to the electronics module 36. That is, it does not communicate through the PEM 34 as in conventional systems.

The transmitter 24 remotely communicates with the entry antenna 32 when within a predefined a distance. The transmitter 24 remotely communicates with the PEM 34 through the entry antenna 32 such that entry to the vehicle is provided. Preferably, an entry signal security code is communicated between the PEM 34 and transmitter 24 to permit authorized entry such as by unlocking the vehicle. Also preferably transmitted is an authorizing signal which authorizes engine start. These entry signals and authorizing signals are preferably encrypted to minimize unauthorized reception and provide singular identification.

If the PEM 34 confirms that the signal from the transmitter 24 is valid, the PEM 34 authorizes the electronics module 36 to commence engine start. Should an unauthorized message be received, the PEM 34 will not authorize the electronics module 36, and no engine start will commence. Additional immobilizer and security features may also be activated.

Should the transmitter 24 have a power source failure, operation of the system 20 and engine start may still be authorized through the passive signaling device 22. The passive signaling device 22 is located adjacent to the transponder antenna 38 which energizes the passive signaling device 22 and provides communication of an authorizing signal therebetween. The transporter antenna then communicates the authorizing signal from the passive signaling device 22 directly to the electronics module 36 to permit engine start. Typically, by inserting the key 30 into a vehicle ignition 42, communication between the passive signaling device 22 and the transponder antenna 38 is provided, however, other placement locations such as the vehicle door lock will also benefit from the present invention. If the passive signaling device 22 is authenticated, the electronics module 36 is authorized to commence engine start as with authorized communication between the PEM 34 and the transmitter 24.

Should the PEM 34 fail, locating the passive signaling device 22 adjacent the transponder 38 will again permit engine start. Whether the transmitter 24 has an operational power source 28 in this scenario is irrelevant, as the communication is between the passive signaling device 22 and the transponder antenna 38. That is, since the transponder antenna 38 does not communicate with the electronics module 36 through the PEM 34, failure of the PEM 34 will not result in a single point failure.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A keyless entry system comprising:
a passive signaling device that provides an authorizing signal; and
a transponder antenna in direct communication with an electronics module, placement of said passive signaling device adjacent said transponder antenna authorizing operation of said electronic module.

2. The keyless entry system as recited in claim 1, further comprising a radio frequency/low frequency transmitter.

3. The keyless entry system as recited in claim 1, wherein said electronics module comprises an engine controller.

4. The keyless entry system as recited in claim 3, wherein said authorizing operation comprises transmitting a start signal to a vehicle engine.

5. The keyless entry system as recited in claim 1, wherein said passive signaling device comprises a vehicle key.

6. A method of operating a keyless entry system comprising the steps of:
(1) locating a passive signaling device adjacent a transponder antenna, the transmitter antenna communicating directly with an electronics module; and
(2) authorizing operation of the electronic module in response to said step (1).

7. A method as recited in claim 6, further comprises the steps of:
commencing a start sequence of a vehicle engine in response to said step (2).

8. A method as recited in claim 6, further comprises the steps of:
remotely transmitting an authorizing signal from a transmitter to a passive entry module; and
authorizing operation of the electronic module in response to reception of the authorizing signal.

9. A method as recited in claim 8, further comprises the steps of:
commencing a start sequence of a vehicle engine in response to said step (2).

10. A method as recited in claim 6, wherein said step (2) occurs without the passive signaling device having an operational power supply.
